(19) United States
(12) Patent Application Publication
(10) Pub. No.: US 2006/0138216 A1
(43) Pub. Date: Jun. 29, 2006

(54) Smart phone with a scan and identification

(75) Inventors: Yi-Tsung Huang, Hsin-Tien City (TW); Shih-Chang Cheng, Hsin-Tien City (TW)

Correspondence Address: BIRCH STEWART KOLASCH & BIRCH, PO BOX 747, FALLS CHURCH, VA, 22040-0747, US

(73) Assignee: LITE-ON SEMICONDUCTOR CORP.

(21) Appl. No.: 11/172,801

(22) Filed: Jul. 5, 2005

(30) Foreign Application Priority Data
Dec. 28, 2004 (TW) 093221061

(51) Int. Cl. G06K 5/00

(52) U.S. Cl. 235/380

(57) ABSTRACT

A smart phone with a scan and identification function is disclosed. The smart phone includes a phone body, a scanning module, a phone processing module and a text identification module. The phone body has a display module disposed thereon. The scanning module is disposed in the phone body, and has a sensor unit for reading image information and a digital processing unit for transforming image information from logic signals into digital signals. The phone processing module is disposed inside the phone body for receiving digital signals from the scanning module. The text identification module is disposed in the phone body for transforming digital signals into texts and displaying texts on the display module. Hence, the present invention overcomes the inconvenience for users of having to key-in information to a cell phone, and achieves the object of quickly inputting text into a cell phone.

### BACKGROUND OF THE INVENTION

1. Field of The Invention

The present invention relates to a smart phone with a scan and identification function, and particularly relates to a smart phone having a scanning module, a phone processing module and a text identification module all integrated together for achieving a scan and identification function.

2. Description of the Related Art

With the coming of age of information technologies, and the improvement of Internet and communication techniques, Cell phones (or mobile phones) have become one of the most common communication tools. Cell phone products are loved and utilized by many consumers for their small and light size, portability, numerous functions and low price. People can send messages to their friends, family or business associates immediately via their cell phone. As such, cell phones are more convenient and faster than traditional wire telephones. Cell phone users regularly receive and send information via wireless communication and can use text messages and emails to achieve this function.

Although users can key-in texts via the keypad of their cell phone, the keypad is usually very small. As such, it's inconvenient for a user to key-in information.

### SUMMARY OF THE INVENTION

The present invention provides a smart phone with a scan and identification function. The smart phone has a scanning module for acquiring image information, and the image information is received by a phone processing module and is transformed into texts by a text identification module. Hence, the present invention overcomes the inconvenience for users of having to key-in information to a cell phone, and achieves an objective of quickly keying texts into a cell phone.

One aspect of the invention is a smart phone with a scan and identification function. The smart phone includes a phone body, a scanning module, a phone process module and a text identification module. The phone body has a display module disposed thereon. The scanning module is disposed in the phone body, and has a sensor unit for reading image information and a digital processing unit for transforming image information from logic signals into digital signals. The phone processing module is disposed in the phone body for receiving the digital signals from the scanning module. The text identification module is disposed in the phone body for transforming the digital signals into texts and displaying the texts on the display module.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block of a smart phone with a scan and identification function according to the present invention; and

FIG. 2 is a perspective, schematic view of a smart phone with a scan and identification function according to the present invention.

### DETAILED DESCRIPTION OF PREFERRED EMBODIMENTS

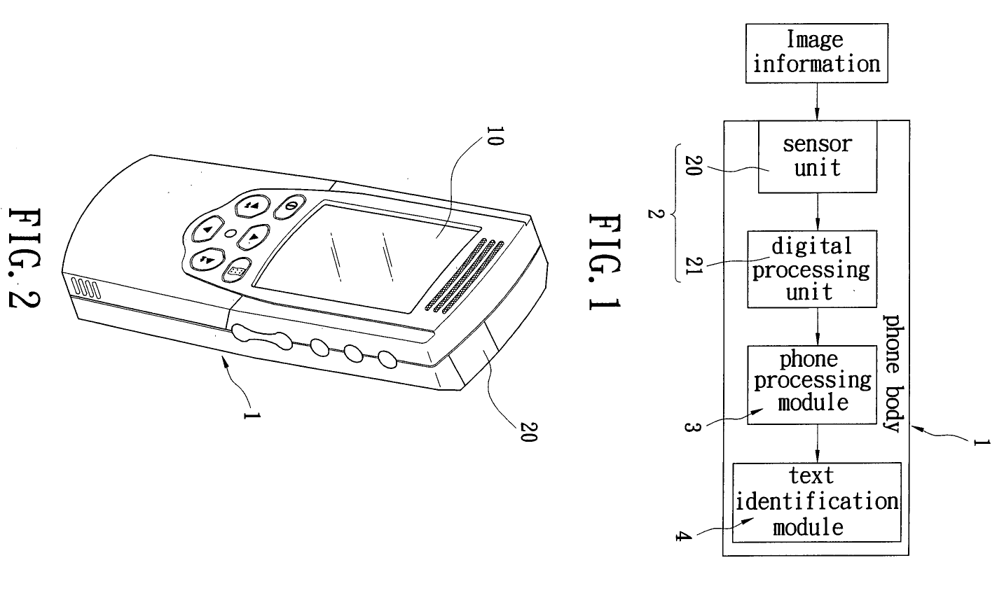

FIG. 1 shows a function block of a smart phone with a scan and identification function according to the present invention. The smart phone includes a phone body 1, a scanning module 2, a phone processing module 3 and a text identification module 4.

The phone body 1 has a display module 10 disposed thereon for displaying picture and text information. The scanning module 2 is disposed in the phone body 1, and has a sensor unit 20 and a digital processing unit 21. The sensor unit 20 is used to read image information, and the digital processing unit 21 is used to transform the image information from logic signals into digital signals. The sensor unit 20 is a sensor, and the sensor can be a CMOS (Complementary Metal-Oxide Semiconductor) sensor or a CCD (Charge Coupled Device) sensor.

The phone processing module 3 is disposed inside of the phone body 1 for receiving the digital signals from the scanning module 2. The phone processing module 3 can be an application processor or a CPU. The text identification module 4 is disposed inside the phone body 1 for transforming the digital signals into texts and displaying the texts on the display module 10. The text identification module 4 has a built-in text identification program installed therein.

FIG. 2 shows a perspective, schematic view of a smart phone with a scan and identification function according to the present invention. The sensor unit 20 is disposed on a top side of the phone body 1. Hence, it is convenient and portable for users to use the smart phone with the scan and identification function. However, the abovementioned arrangement of the sensor unit 20 does not limit the present invention. The sensor unit 20 can be disposed on any position of outside of the phone body 1 for that lets the sensor unit 20 to scan and identify text.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A smart phone with a scan and identification function, comprising:
a phone body having a display module disposed thereon;
a scanning module disposed in the phone body, and having a sensor unit for reading image information and a digital processing unit for transforming the image information from logic signals into digital signals;
a phone processing module disposed in the phone body for receiving the digital signals from the scanning module; and
a text identification module disposed in the phone body for transforming the digital signals into texts and displaying the texts on the display module.

2. The smart phone as claimed in claim 1, wherein the sensor unit is a sensor.

3. The smart phone as claimed in claim 2, wherein the sensor is a CMOS sensor.

4. The smart phone as claimed in claim 2, wherein the sensor is a CCD sensor.

5. The smart phone as claimed in claim 1, wherein the phone processing module is an application processor.

6. The smart phone as claimed in claim 1, wherein the text identification module has text identification program installed therein.

7. The smart phone as claimed in claim 1, wherein the sensor unit is disposed on a top side of the phone body.
